(19) United States
(12) Patent Application Publication
(10) Pub. No.: US 2025/0324490 A1
(43) Pub. Date: Oct. 16, 2025

(54) HEATING GLASS AND GLASS FILLING OF A WINDOW STRUCTURE COMPRISING THE HEATING GLASS

(71) Applicant: VOLTGLASS S.R.0., Hradec Kralove (CZ)

(72) Inventor: Dana MAKAROVOVA OUHRABKOVA, Hradec Kralove (CZ)

(73) Assignee: VOLTGLASS S.R.0., Hradec Kralove (CZ)

(21) Appl. No.: 18/870,482

(22) PCT Filed: May 26, 2023
(86) PCT No.: PCT/CZ2023/050028

§ 371 Date: Nov. 29, 2024

(30) Foreign Application Priority Data
May 30, 2022 (CZ) PV2022-228

(51) Int. Cl. H05B 3/86; E06B 3/67; E06B 7/12

(52) U.S. Cl. CPC H05B 3/86; E06B 3/67; E06B 7/12; H05B 2203/011; H05B 2203/013

(57) ABSTRACT

The heating glass, which comprises a glass sheet (1), where its one surface comprises a solid conductive coating of metal oxide, which is in a form of a mesh (2) with conductive paths, where two contact surfaces (3) are formed on at least part of the edge of the mesh (2), which comprises a layer (4) of a zinc-aluminum alloy, on which a layer (5) of a zinc-copper alloy is applied, where the mesh (2) is performed in distance from the edge of the glass sheet (1), the layer (4) of the zinc-aluminum alloy comprises abrasive particles, where the abrasive particles are corundum, and on the layer (5) of the zinc-copper alloy is placed a conductive strip (7) with an attached electrical contact (8).

### BACKGROUND OF THE INVENTION

The invention relates to a heating glass and a glass filling of the window structure comprising the heating glass.

### STATE OF THE ART

In the present time, an electrically heated glass is known, where for its construction a laminated glass is used, which is produced by hot pressing, i.e. triplex. Heating elements contained in it are in a form of threads made of heat-resistant metals or a metallized layer integrated into the foil and placed between the triplex layers. When weak current (12-24V) is supplied, an electrical energy is converted into a thermal energy, so heating occurs.

Disadvantage of the above presented solution is, that the heating technology is implemented only, when the triplex is used, i.e. pressed triple glass. Furthermore, the heating element cannot be used without a transformer, the heating range is limited to temperature 60° C. or 90° C., and low operational stability during voltage drops occurs.

The document RU2510704 describes a heating glass provided with an electrically conductive coating based on a metal oxide, where hexagons are burned by laser, so a hexagonal network is created. The opposite edges of the network, or glass panes, are provided with a layer of zinc-aluminum alloy, where a layer of zinc-copper alloy with attached electrical contacts is applied on it. When the glass is used for laminated windows, sealing frames are placed between the glasses. When it is used, the electric current, which is coming through the conductive layer, releases thermal energy in the infrared region of the radiation spectrum, which is evenly distributed over the entire surface of the product.

Disadvantage of the above mentioned performance is, that it is dangerous, because the frames allow passing of the current through, the layers of the applied alloys don't hold on the glasses sufficiently, and the connection of the wires is not effective enough.

The aim of the invention is to present such solution that would eliminates the above-mentioned disadvantages of the state of the art.

### FEATURE OF THE INVENTION

The above mentioned disadvantages are considerably eliminated by heating glass, which comprises a glass sheet 1, where its one surface comprises a solid conductive coating of metal oxide, which is in a form of a mesh 2 with conductive paths, where two contact surfaces 3 are formed on at least part of the edge of the mesh 2, which comprises a layer 4 of a zinc-aluminum alloy, on which a layer 5 of a zinc-copper alloy is applied, where the mesh 2 is performed in distance from the edge of the glass sheet 1, the layer 4 of the zinc-aluminum alloy comprises abrasive particles, where the abrasive particles are corundum, and on the layer 5 of the zinc-copper alloy is placed a conductive strip 7 with an attached electrical contact 8.

In advantages embodiment the amound of the corundum is 2-20%, preferably 2-10%, of the weight of the mixture.

In other advantages embodiment the strip Z is connected to the layer 5 of the zinc-copper alloy by an adhesive layer and/or by spot soldering.

In other advantages embodiment the mesh 2 is 1 to 2 cm away from the edge of the glass sheet 1.

The above mentioned disadvantages are considerably eliminated also by at least one glass panel 9 is the heating glass according to one of the claims 1 to 4, where the glass panels 9 are circumferentially separated to each other by a spacer frame 10, where a sealed gas chamber 11 is sealed between the glass panels 9 and the spacer frame 10, where the spacer frame 10 is equipped by insulating adhesive seal on its outside, where the spacer frame 10 is fixed in the glass filling by a layer 6 of dielectric sealant.

In advantages embodiment the sealed gas chamber 11 is filled with air or argon.

In other advantages embodiment the spacer frame 10 is made of a dielectric material.

### DESCRIPTION OF THE DRAWINGS

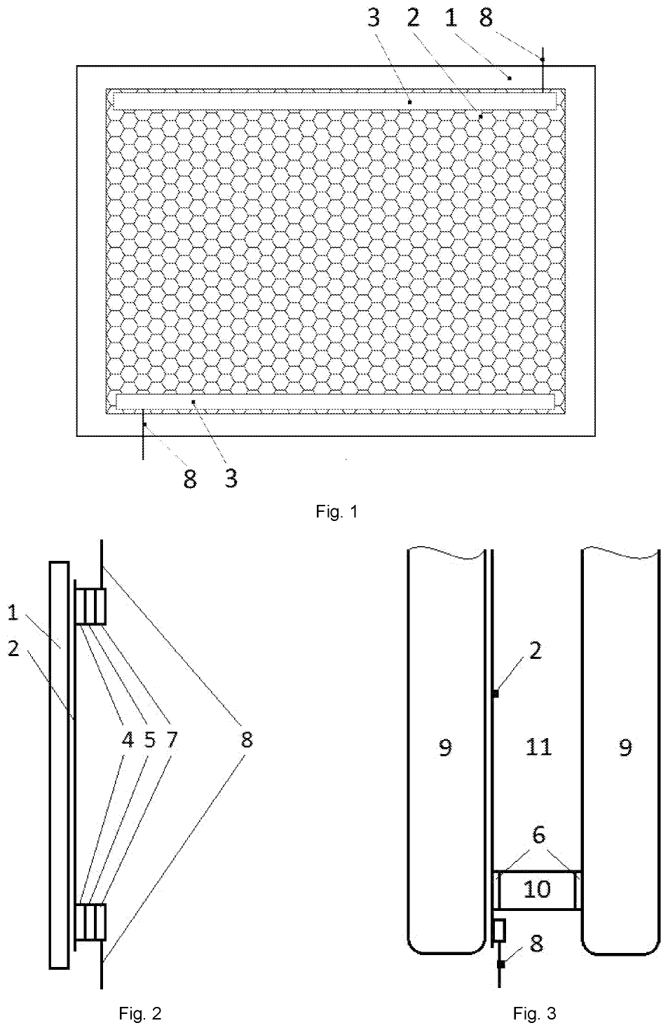

The invention will be further clarified by use of figures, where FIG. 1 presents a view of the heating glass according to the invention, FIG. 2 presents a side view of the heating glass according to the invention, and FIG. 3 presents the glass filling of the window structure according to the invention.

### Preferred Embodiments of the Invention

The heating glass according to the invention, shown in FIGS. 1 and 2, comprises a glass sheet 1, where its one surface comprises a solid conductive coating of a metal oxide, which is in a form of a mesh 2 with conductive paths, for example in the form of hexagonal meshes, which is placed in distance from the edge of the glass sheet 1, where two contact surfaces 3 are formed on at least part of the edge of the mesh 2, which comprises a layer 4 of a zinc-aluminum alloy, which comprises abrasive particles, on which a layer 5 of a zinc-copper alloy is applied, on which a conductive strip Z with an electrical contact 8 is placed.

The contact surfaces 3 with the layers 4, 5 of alloys are either both located on one side of the edge of the mesh 2, or on opposite edges of the mesh 2.

In a preferred embodiment, the abrasive particles are corundum of an amount e.g. 2-20%, preferably 2-10%, of the weight of the mixture, which significantly improve adhesion during application.

Preferably, the conductive strip Z is made of copper.

The connection of the conductive strip Z is performed by applying an adhesive layer and/or by spot soldering.

For example, the material of the glass sheet 1 is a glass, a tempered glass, or the triplex, and the shape is rectangle, circle, square, or polygon, with the thickness at least 3 mm.

Preferably, the mesh 2 is in distance 1-2 cm away from the edge of the glass sheet 1, to ensure additional safeness and to prevent electric shock in case of mechanical destruction of a spacer frame.

The subject of the invention is also the glass filling of the window structure, presented in FIG. 3, which comprises:
at least two glass panels 9, where
at least one glass panel 9 is the heating glass according to the invention,
where the glass panels 9 are separated from each other around the perimeter by spacer frame 10 to perform a sealed gas chamber 11 between the glass panels 9, where insulating adhered seal is arranged on its outside, not shown in the figure, where
the gas chamber 11 is filled with air or argon to reduce thermal conductivity.

Possibly, the number of the chambers 11 depends on the number of the panels 9, for example two chambers, when two outer panels and one central panel is used.

Advantageously, some of the glass panels 9 is formed by two parallel glasses fitted together, between which an electrochromic layer is advantageously placed.

Preferably, some of the glasses are provided with a low-emission coating or a dimmable film, so-called a smart film, both in the space between two parallel glass panels and in the space inside the chamber 11.

The insulating and adhesive seals are preferably made of the isobutyl, which has necessary properties against moisture penetration and oxidation of the used metal alloys.

Dielectric sealants are mainly used for sealing. Use of sealants having butyl or other basis, where to its production electrically conductive additives are used, is excluded, which makes possible to prevent its contact with the conductive side of the glass, so to prevent unacceptable heating of the body of the sealing layer.

The spacer frame 10 is made of a dielectric material, which excludes its possible short circuit with a conductive bus (busbar/track) or soldering points, and also contributes correct flow of current along the conductive paths of the mesh 2.

The spacer frame 10 is fixed in the glass filling by layer 6 of the dielectric sealant. This sealant is specifically located in the interface between the spacer frame 10 and the glass panels 9, either directly or indirectly. A possible variant is a placement of this sealant in the interface between the spacer frame 10 and the mesh 2.

The production of the heating glass according to the invention is as follows:

Before the glass is subjected to the standard tempering process, it is beveled to relieve stress points. After that, the glass is heated to a temperature of 650-680° C. and then rapidly uniformly cooled by air. Because of that, residual mechanical compressive stresses are created in the surface layers of the glass, to ensure its increased mechanical strength, heat resistance and safeness in case of its destruction. Subsequently, a solid conductive coating is applied to the glass, which is sprayed onto the surface under pressure.

After its application, a layer of conductive coating along the edge of the glass is removed by laser, and for example by burning of hexagonal holes, the mesh 2 with the conductive lines is created.

When the unwanted layers of the conductive coating are removed, the layer 4 of a zinc-aluminum alloy, which comprises abrasive particles is applied, on which the layer 5 of a zinc-copper alloy is subsequently applied, on which the layer 6 of dielectric sealant is subsequently applied, on which the conductive strip Z is placed with connected electrical contacts 8.

The creation of the structure of the conductive paths can be done both before and after the glass tempering process.

The advantages of the heating glass according to the invention is:
removal of a cold window effect, which occurs, when outside temperature is below zero,
creating a temperature on the glass surface above the dew point, which excludes condensation,
reflection of the heat back into a room during a cold weather, even during a switched off state, and in a hot season the glass does not transmit heat into a house,
preventing eavesdropping of a room with a directional laser beam, as the conductive coating of the glass can serve as an intrusion sensor, and it can be directly connected to a security system and a smart home system, and
a resistance to voltage drop, heating up to 300° C. and thermal shocks.

Possible use of the heating glass according to the invention for:
the heavy traffic engineering (cabins of tower cranes, heavy vehicles and special equipment),
the aviation industry (a glass of navigation towers or cockpits),
shipbuilding (a glass of a captain's cabin),
greenhouses and conservatories (glazing and glass roofing),
the public transport (heated bus stops and public transport stops, underground metro and railway stations, thermal stations), etc.

1. The heating glass, which comprises a glass sheet (1), where its one surface comprises a solid conductive coating of a metal oxide, which is in a form of a mesh (2) with conductive paths, where two contact surfaces (3) are formed on at least part of the edge of the mesh (2), which comprises a layer (4) of a zinc-aluminum alloy, on which a layer (5) of a zinc-copper alloy is applied, characterized in, that the mesh (2) is performed in distance from the edge of the glass sheet (1), the layer (4) of the zinc-aluminum alloy comprises abrasive particles, where the abrasive particles are corundum, and on the layer (5) of the zinc-copper alloy is placed a conductive strip (7) with an attached electrical contact (8).

2. Heating glass according to claim 1, characterized in, that amound of the corundum is 2-20%, preferably 2-10%, of the weight of the mixture.

3. Heating glass according to one of claims 1 to 2, characterized in, that the strip (7) is connected to the layer (5) of the zinc-copper alloy by an adhesive layer and/or by spot soldering.

4. Heating glass according to one of claims 1 to 3, characterized in, that the mesh (2) is 1 to 2 cm away from the edge of the glass sheet (1).

5. Glass filling of a window structure, which comprises at least two glass panels (9), characterized in, that at least one glass panel (9) is the heating glass according to one of the claims 1 to 4, where the glass panels (9) are circumferentially separated to each other by a spacer frame (10), where a sealed gas chamber (11) is sealed between the glass panels (9) and the spacer frame (10), where the spacer frame (10) is equipped by insulating adhesive seal on its outside, where the spacer frame (10) is fixed in the glass filling by a layer (6) of dielectric sealant.

6. Glass filling of a window structure according to claim 5, characterized in, that the sealed gas chamber (11) is filled with air or argon.

7. Glass filling of a window structure according to one of claim 5 or 6, characterized in, that the spacer frame (10) is made of a dielectric material.
